(19) United States
(12) Patent Application Publication
(10) Pub. No.: US 2004/0017785 A1
(43) Pub. Date: Jan. 29, 2004

(54) System for transporting multiple radio frequency signals of a multiple input, multiple output wireless communication system to/from a central processing base station

(76) Inventor: Allert van Zelst, Woerden (NL)

Correspondence Address: HARNESS, DICKEY & PIERCE, P.L.C., P.O. BOX 8910, RESTON, VA, 20195, US

(21) Appl. No.: 10/195,504

(22) Filed: Jul. 16, 2002

(51) Int. Cl. H04Q 7/00

(52) U.S. Cl. 370/328; 370/535

(57) ABSTRACT

The system includes, at least first and second antennas receiving first and second radio frequency signals, and a multiplexing system converting the first and second radio frequency signals to first and second optical signals and multiplexing the first and second optical signals for transmission over the optical fiber. A central processing base station is adapted for connection to the optical fiber. The central processing base station demultiplexes the first and second optical signals from the optical fiber, converts the first and second optical signals into the first and second radio frequency signals, and processes the first and second radio frequency signals to obtain information signals. In another embodiment, a conductor such as a coaxial cable replaces the optical fiber, and the multiplexer multiplexes the first and second radio frequency signals onto the conductor. In a further embodiment, the central processing base station uses the same techniques to send signals to an access point for transmission.

### BACKGROUND OF THE INVENTION

1. Field of the Invention

The present invention relates to the field of telecommunications; and more particularly, to a system for transporting multiple radio frequency signals of a multiple input, multiple output (MIMO) wireless communication system to/from a central processing base station.

2. Description of Related Art

In the interest of reducing costs, centralizing the base station processing tasks of a telecommunications system has been proposed. In this system, the individual cell no longer includes the base station processing within the cell itself. Instead, each cell is reduced to a very low cost access point. Each access point includes an antenna for receiving a signal at a particular radio frequency, a converter for converting the received radio frequency signal into an optical signal, and an optical transmitter for transmitting the optical signal to a centralized base station over an optical fiber. Accordingly, in this system, each antenna is connected to the centralized base station by its own optical fiber. This technique has become to be known as radio over fiber or RoF. At the centralized base station, the optical signals are converted back to radio frequency signals, the radio frequency signals are mixed down or converted to baseband, and the baseband signals are processed in the known manner.

However, multiple input, multiple output (MIMO) communication techniques have been proposed as the next step in the evolution of wireless communication. Multiple input, multiple output (MIMO) communication techniques such as space division multiplexing (SDM) provide the promise of achieving tremendous bandwidth efficiencies where multipath scattering of the wireless channel is sufficiently rich and properly exploited. Unlike the single input, single output (SISO) system described above, MIMO communication techniques such as SDM involve the simultaneous transmission of different signals on different antennas spaced at least a half wavelength apart.

The creation of the different signals to be sent with the different transmit antennas is dissimilar for different MIMO algorithms. Firstly, the incoming data at the transmitter can be sent with more redundancy in the spatial domain to create a more reliable communication link. One way to include this redundancy, is by copying the incoming data onto the multiple transmit antennas and only altering the phase per antenna. In this way a beam is formed towards a specific direction. This technique is called beamforming, and is disclosed by J. E. Hudson in “Adaptive Array Principles”, IEE Electromagnetic Wave Series No. 11, Peter Peregrinus, Stevenage, UK, 1981, hereby incorporated by reference in its entirety. Secondly, the redundancy can be added by coding in such a way that the incoming data is coded over space. This technique is called Space-Time Coding, and is disclosed by V. Tarokh, N. Seshadri and A. R. Calderbank in “Space-Time Codes for High Data Rate Wireless Communication: Performance Criterion and Code Construction”, IEEE Transactions on Information Theory, vol. 44, March 1998, no. 3, pp. 744-756, hereby incorporated by reference in its entirety. Or, the incoming data can be multiplexed onto the different transmit antennas, i.e., spatial multiplexing or Space Division Multiplexing such as disclosed by G. J. Foschini in “Layered Space-Time Architecture for Wireless Communication in a Fading Environment When Using Multi-Element Antennas”, Bell Labs Technical Journal, vol. 1, no. 2, autumn 1996, hereby incorporated by reference in its entirety, and disclosed by the inventor in “Spatial Division Multiplexing Algorithms”, 10th Mediterranean Electrotechnical Conf. (MELECON) 2000, Cyprus, May 2000, Vol. 3, pp. 1218-1221, hereby incorporated by reference in its entirety. Also, hybrids of above techniques are possible.

Because the signals are sent on the same frequency due to the richly scattered environment, the parallel stream of data are mixed in the air, but can be recovered at the receiver using one of a number of MIMO algorithms. Typically, these demultiplexing and/or decoding algorithms require the use of multiple antennas to ensure adequate performance. As a result, the number of antennas at each access point will greatly increase, causing a dramatic increase in the number of optical fibers leading to the centralized base station where the demultiplexing operation is performed. Such a large increase in the number of optical fibers defeats in part the cost savings that is to be realized by centralizing the base station processing task.

### SUMMARY OF THE INVENTION

In the system for transporting multiple radio frequency signals of a multiple input, multiple output wireless communication system to a central processing base station according to the present invention, the signals to be transported to a centralized base station are multiplexed for transmission over a single optical fiber, in one embodiment, or conductor (e.g., coaxial cable) in another embodiment. Thus, the number of optical fibers or conductors leading to the centralized base station in a MIMO communication system remains substantially unchanged from those in a single output, single input system (SISO).

In one embodiment, received radio frequency signals are converted into optical signals, and optical multiplexing techniques such as wave division multiplexing (WDM) or dispersive multiplexing are used to multiplex the optical signals for transmission over a single optical fiber for transport to the centralized base station. In another embodiment, frequency division multiplexing or any other known electromagnetic signal multiplexing technique is used to multiplex the received radio frequency signals for transmission over a single conductor, such as a coaxial cable, for transport to the centralized base station. In a further embodiment, the same techniques are used to transport radio frequency signals from the centralized base station. In this embodiment, the centralized base station generates radio frequency signals, converts the radio frequency signals to first and second optical signals, and multiplexes the optical signals for transmission over an optical fiber. An access point, adapted for connection to the optical fiber, demultiplexes the optical signals on the optical fiber and converts the optical signals into radio frequency signals, which are then transmitted over respective antennas.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates a system for transporting multiple radio frequency signals of a multiple input, multiple output wireless communication system to a central processing base station according to one embodiment of the present invention;

FIG. 2 illustrates part of a system for transporting multiple radio frequency signals of a multiple input, multiple output wireless communication system to a central processing base station according to another embodiment of the present invention;

FIG. 3 illustrates a system for transporting multiple radio frequency signals of a multiple input, multiple output wireless communication system to a central processing base station according to a further embodiment of the present invention; and

FIG. 4 illustrates a system for transporting multiple radio frequency signals of a multiple input, multiple output wireless communication system from a central processing base station to the mobile terminal(s) according to one embodiment of the present invention.

### DETAILED DESCRIPTION OF THE EMBODIMENTS

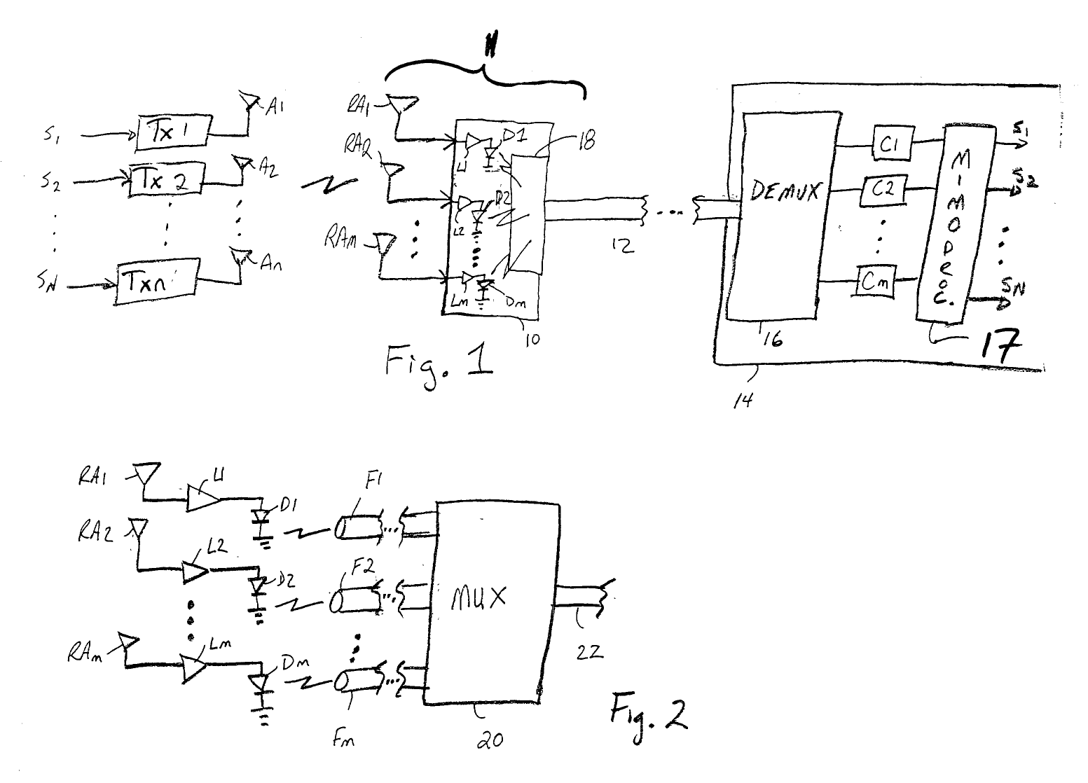

FIG. 1 illustrates a system for transporting multiple radio frequency signals of a multiple input, multiple output wireless communication system to a central processing base station according to one embodiment of the present invention. As shown, information signals S1 . . . Sn generated according to any well-known MIMO technique (e.g., space division multiplexing, space-time coding, beam forming, diversity, etc., or a hybrid of such techniques), are respectively transmitted by a plurality of transmitters Tx1 . . . Txn via a corresponding plurality of antennas A1 . . . An established by the employed MIMO technique. The transmitted signals are received by a plurality of receive antennas RA1 . . . Ram at an access point 11. The number of receive antennas m depends on the MIMO technique employed and the transmission/reception environment. Accordingly, m will vary depending on the design constraints such that m may be greater than, equal to or less than n.

A multiplexer 10 at the access point 11 converts the received radio frequency (RF) signal from each receive antenna A1 . . . Am into an optical signal, and multiplexes the optical signals onto the single optical fiber 12. In the multiplexer 10, each of the RF signals received by each receive antenna RA1 . . . RAm is amplified by a respective (linear) amplifier L1 . . . Lm and converted into an optical signal by a respective light emitting diode D1 . . . Dm. A multiplexing unit 18 then multiplexes the optical signals onto the single optical fiber 12 using well-known wave division multiplexing (WDM) or dispersive multiplexing techniques.

A centralized base station 14 is connected to the single optical fiber 12. A demultiplexer 16 in the centralized base station 14 demultiplexes the optical signals from the single optical fiber in accordance with the inverse of the multiplexing technique used by the multiplexing unit 18, and converts the respective optical signals into respective RF signals using, for example, photodiodes. Each RF signal output by the demultiplexer 16 corresponds to one of the RF signals received by the receive antennas A1 . . . Am. Each RF signal output by the demultiplexer 16 is converted by a respective converter C1 . . . Cm into a baseband signal.

A MIMO processor 17 converts the baseband signals back into information signals according to the MIMO algorithm (e.g., space division multiplexing, space-time coding, beam forming, diversity, etc., or a hybrid of such techniques). The information signals are then processed by the base station in the well-known manner.

By multiplexing the RF signals onto a single transport optical fiber, the complexity and cost of employing a centralized base station in a MIMO telecommunication system does not dramatically increase as compared to a SISO telecommunication system.

FIG. 2 illustrates part of a system for transporting multiple radio frequency signals of a multiple input, multiple output wireless communication system to a central processing base station according to another embodiment of the present invention. Because the embodiment of FIG. 2 is substantially the same as the embodiment of FIG. 1, only the differences between the two embodiments will be described for the sake of brevity.

In the embodiment of FIG. 1, the multiplexer 10 is collocated with the receive antennas RA1 . . . RAm. However, co-location is not always possible, and the multiplexer may have to be located some short distance from the receive antennas RA1 . . . RAm. In this instance, the RF signal received by each receive antenna RA1 . . . RAm is amplified by a respective (linear) amplifier L1 . . . Lm and converted into an optical signal by a respective light emitting diode D1 . . . Dm. Each optical signal is transported by a respective optical fiber F1 . . . Fm to a multiplexer 20. The multiplexer 20 multiplexes the optical signals onto the single optical fiber 22 leading to the centralized base station 14 using well-known wave division multiplexing (WDM) or dispersive multiplexing techniques.

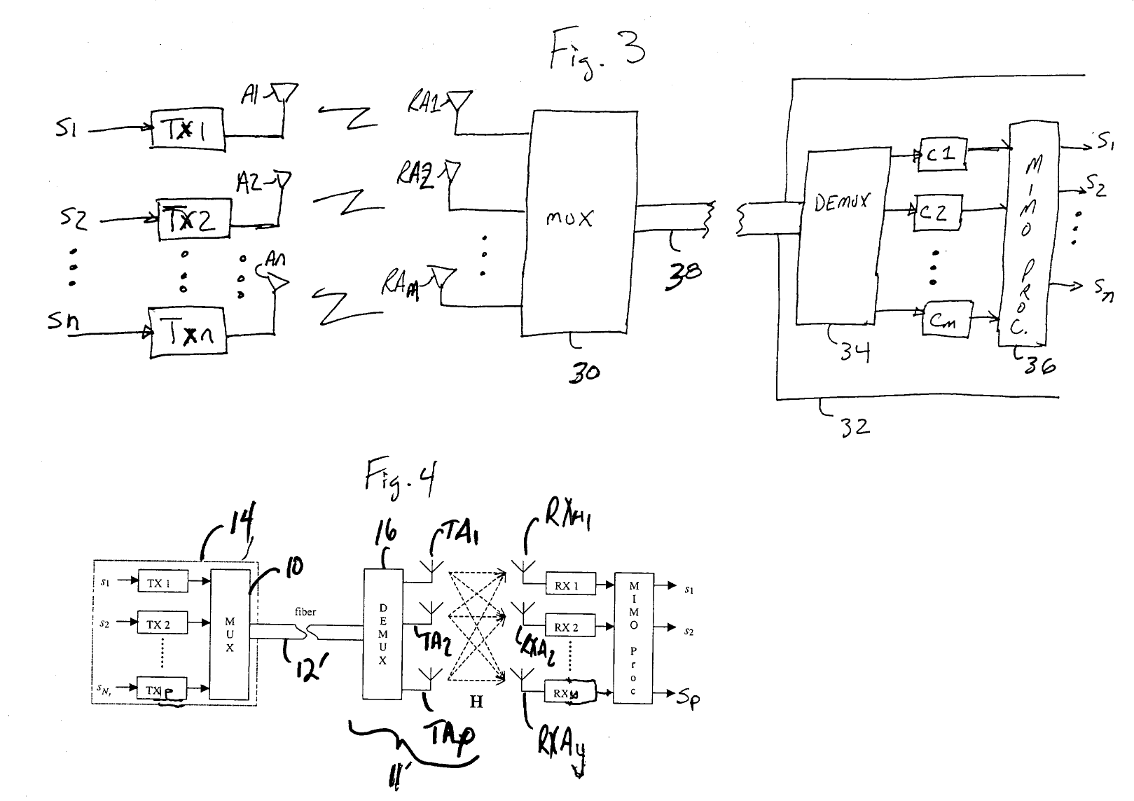

FIG. 3 illustrates part of a system for transporting multiple radio frequency signals of a multiple input, multiple output wireless communication system to a central processing base station according to a further embodiment of the present invention. As shown, information signals S1 . . . Sn generated according to any well-known MIMO technique (e.g., space division multiplexing, space-time coding, beam forming, diversity, etc., or a hybrid of such techniques), are respectively transmitted by a plurality of transmitters TX1 . . . Txn via a corresponding plurality of antennas A1 . . . An established by the employed MIMO technique. The transmitted signals are received by a plurality of receive antennas RA1 . . . RAm. The number of receive antennas m depends on the MIMO technique employed and the transmission/reception environment. Accordingly, m will vary depending on the design constraints such that m may be greater than, equal to or less than n.

A multiplexer 30 multiplexes the RF signals onto a single conductor 38 (e.g., coaxial cable, twisted pair, etc. using well-known radio frequency signal multiplexing techniques such as frequency division multiplexing.

A centralized base station 32 is connected to the single conductor 38. A demultiplexer 34 in the centralized base station demultiplexes the RF signals from the single conductor 38. Each RF signal output by the demultiplexer 34 corresponds to one of the RF signals received by the receive antennas A1 . . . Am. Each RF signal output by the demultiplexer 34 is converted by a respective converter C1 . . . Cm into a baseband signal.

A MIMO processor 36 converts the baseband signals back into information signals according to the MIMO algorithm (e.g., space division multiplexing, space-time coding, beam forming, diversity, etc., or a hybrid of such techniques). The information signals are then processed by the base station in the well-known manner.

By multiplexing the RF signals onto a single conductor for transport, the complexity and cost of employing a centralized base station in a MIMO telecommunication system does not dramatically increase as compared to a SISO telecommunication system.

FIG. 4 illustrates a system for transporting multiple radio frequency signals of a multiple input, multiple output wireless communication system from a central processing base station according to one embodiment of the present invention. Because many of the elements in this embodiment are the same as those described above with respect to the embodiment of FIG. 1, the same reference numerals have been used for the same elements. As shown, information signals S1 . . . Sp generated according to any well-known MIMO technique (e.g., space division multiplexing, space-time coding, beam forming, diversity, etc., or a hybrid of such techniques), are respectively prepared for transmission by a plurality of transmitters Tx1 . . . Txp established by the employed MIMO technique. A multiplexer 10 converts each of the radio frequency (RF) signals from the plurality of transmitters Tx1 . . . Txp into an optical signal, and multiplexes the optical signals onto the single optical fiber 12′ using well-known wave division multiplexing (WDM) or dispersive multiplexing techniques.

An access point 11′ is connected to the single optical fiber 12′. A demultiplexer 16 in the access point 11′ demultiplexes the optical signals from the single optical fiber in accordance with the inverse of the multiplexing technique used by the multiplexer 10, and converts the respective optical signals into respective RF signals using, for example, photodiodes. Each RF signal output by the demultiplexer 16 corresponds to one of the RF signals generated by the plurality of transmitters Tx1 . . . Txp. Each RF signal output by the demultiplexer 16 is transmitted by a respective antenna TA1 . . . TAp.

The transmitted signals are received by a plurality of receive antennas RXA1 . . . RXAy. The number of receive antennas y depends on the MIMO technique employed and the transmission/reception environment. Accordingly, y will vary depending on the design constraints such that y may be greater than, equal to or less than p. A MIMO processor 17 converts the baseband signals back into information signals according to the MIMO algorithm (e.g., space division multiplexing, space-time coding, beam forming, diversity, etc., or a hybrid of such techniques). The information signals are then processed in the well-known manner.

By multiplexing the RF signals onto a single transport optical fiber, the complexity and cost of employing a centralized base station in a MIMO telecommunication system does not dramatically increase as compared to a SISO telecommunication system.

The invention being thus described, it will be obvious that the same may be varied in many ways. Such variations are not to be regarded as a departure from the spirit and scope of the invention, and all such modifications are intended to be included within the scope of the following claims.

I claim:

1. A system for transporting multiple radio frequency signals of a multiple input, multiple output wireless communication system to a central processing base station, comprising:
at least first and second antennas receiving first and second radio frequency signals;
a multiplexing system converting the first and second radio frequency signals to first and second optical signals, and multiplexing the first and second optical signals for transmission over an optical fiber;
a central processing base station adapted for connection to the optical fiber, the central processing base station demultiplexing the first and second optical signals from the optical fiber, converting the first and second optical signals into the first and second radio frequency signals, and processing the first and second radio frequency signals to obtain information signals.

2. The system of claim 1, wherein the first and second radio frequency signals are transmitted according to a multiple input, multiple output transmission technique.

3. The system of claim 1, wherein the first and second radio frequency signals are transmitted according to one of space division multiplexing, space-time coding, beam forming, diversity, and a hybrid of these techniques.

4. The system of claim 1, wherein the multiplexing system multiplexes the first and second optical signals for transmission over the optical fiber using wave division multiplexing.

5. The system of claim 1, wherein the multiplexing system multiplexes the first and second optical signals for transmission over the optical fiber using dispersive multiplexing.

6. The system of claim 1, wherein the central processing base station comprises:
a demultiplexer demultiplexing the first and second optical signals from the optical fiber and converting the first and second optical signals into the first and second radio frequency signals;
first and second converters converting the first and second radio frequency signals to first and second baseband signals, respectively; and
a multiple input, multiple output processor converting the first and second baseband signals into information signals.

7. A system for transporting multiple radio frequency signals of a multiple input, multiple output wireless communication system to a central processing base station, comprising:
at least first and second antennas receiving first and second radio frequency signals;
at least first and second optical converters respectively converting the first and second radio frequency signals into first and second optical signals, and respectively placing the first and second optical signals on first and second optical fibers;
a multiplexing system multiplexing the first and second optical signals from the first and second optical fibers for transmission over a main transportation optical fiber;
a central processing base station adapted for connection to the main transportation optical fiber, the central processing base station demultiplexing the first and second optical signals from the main transportation optical fiber, converting the first and second optical signals into the first and second radio frequency signals, and processing the first and second radio frequency signals to obtain information signals.

8. The system of claim 7, wherein the first and second radio frequency signals are transmitted according to a multiple input, multiple output transmission technique.

9. The system of claim 7, wherein the first and second radio frequency signals are transmitted according to one of space division multiplexing, space-time coding, beam forming, diversity, and a hybrid of these techniques.

10. The system of claim 7, wherein the multiplexing system multiplexes the first and second optical signals for transmission over the main transportation optical fiber using wave division multiplexing.

11. The system of claim 7, wherein the multiplexing system multiplexes the first and second optical signals for transmission over the main transportation optical fiber using dispersive multiplexing.

12. The system of claim 7, wherein the central processing base station comprises:
a demultiplexer demultiplexing the first and second optical signals from the main transportation optical fiber and converting the first and second optical signals into the first and second radio frequency signals;
first and second converters converting the first and second radio frequency signals to first and second baseband signals, respectively; and
a multiple input, multiple output processor converting the first and second baseband signals into information signals.

13. A system for transporting multiple radio frequency signals of a multiple input, multiple output wireless communication system to a central processing base station, comprising:
at least first and second antennas receiving first and second radio frequency signals;
a multiplexing system multiplexing the first and second radio frequency signals for transmission over a main transportation cable;
a central processing base station connected to the cable, the central processing base station demultiplexing the first and second optical signals from the main transportation cable, and processing the first and second radio frequency signals to obtain information signals.

14. The system of claim 13, wherein the first and second radio frequency signals are transmitted according to a multiple input, multiple output transmission technique.

15. The system of claim 14, wherein the first and second radio frequency signals are transmitted according to one of space division multiplexing, space-time coding, beam forming, diversity, and a hybrid of these techniques.

16. The system of claim 13, wherein the main transportation cable is a coaxial cable.

17. The system of claim 13, wherein the multiplexing system multiplexes the first and second radio frequency signals for transmission over the main transportation cable using one of frequency division multiplexing and time division multiplexing.

18. The system of claim 13, wherein the central processing base station comprises:
a demultiplexer demultiplexing the first and second radio frequency signals from the main transportation cable;
first and second converters converting the first and second radio frequency signals to first and second baseband signals, respectively; and
a multiple input, multiple output processor converting the first and second baseband signals into information signals.

19. The system of claim 13, further comprising:
at least first and second secondary cables carrying the first and second radio frequency signals, respectively, from the first and second antennas to the multiplexing system.

20. An access point, comprising:
at least first and second receive antennas receiving first and second radio frequency signals; and
a multiplexer converting the first and second radio frequency signals into first and second optical signals and multiplexing the first and second optical signals for transmission over a single optical fiber for transport to a centralized base station.

21. The access point of claim 20, wherein the first and second radio frequency signals are received versions of transmitted signals according to a multiple input, multiple output transmission technique.

22. The access point of claim 20, wherein the multiplexer multiplexes the first and second optical signals for transmission over the optical fiber using one of wave division multiplexing and dispersive multiplexing.

23. An access point, comprising:
a demultiplexer, connected to an optical fiber, demultiplexing a composite optical signal into at least first and second optical signals and converting the first and second optical signals into first and second radio frequency signals; and
at least first and second antennas respectively transmitting the first and second radio frequency signals.

24. The access point of claim 23, wherein the demultiplexer demultiplexes the first and second optical signals from the optical fiber using one of wave division demultiplexing and dispersive demultiplexing.

25. A system for transporting multiple radio frequency signals of a multiple input, multiple output wireless communication system from a central processing base station, comprising:
a central processing base station adapted for connection to the optical fiber, the central processing base station generating at least first and second radio frequency signals, converting the first and second radio frequency signals to first and second optical signals, and multiplexing the first and second optical signals for transmission over the optical fiber; and
an access point, adapted for connection to the optical fiber, demultiplexing the first and second optical signals on the optical fiber and converting the first and second optical signals into first and second radio frequency signals; and
at least first and second antennas respectively transmitting the first and second radio frequency signals.

26. The system of claim 25, wherein the first and second radio frequency signals are transmitted according to a multiple input, multiple output transmission technique.

27. The system of claim 25, wherein the first and second radio frequency signals are transmitted according to one of space division multiplexing, space-time coding, beam forming, diversity, and a hybrid of these techniques.

28. The system of claim 25, wherein the central processing base station multiplexes the first and second optical signals for transmission over the optical fiber using wave division multiplexing.

29. The system of claim 25, wherein the central processing base station multiplexes the first and second optical signals for transmission over the optical fiber using dispersive multiplexing.
